(19) United States
(12) Patent Application Publication
(10) Pub. No.: US 2022/0262408 A1
(43) Pub. Date: Aug. 18, 2022

(54) BASE PLATE, SPINDLE MOTOR, DISK DRIVE APPARATUS AND MANUFACTURING METHOD OF BASE PLATE

(71) Applicant: NIDEC CORPORATION, Kyoto (JP)

(72) Inventors: Michihiro ITO, Kyoto (JP); Ryo FURUYA, Kyoto (JP)

(73) Assignee: NIDEC CORPORATION, Kyoto (JP)

(21) Appl. No.: 17/673,706

(22) Filed: Feb. 16, 2022

(30) Foreign Application Priority Data
Feb. 18, 2021 (JP) 2021-024677

(51) Int. Cl. G11B 33/02

(52) U.S. Cl. CPC G11B 33/022

(57) ABSTRACT

A base plate is a portion of a housing of a disk drive apparatus, including a base body defined by a metal die cast member, and an electrodeposition coating film covering at least a portion of a surface of the base body. The base body includes a bottom plate rectangular as viewed from an axial direction, and a pivot post. The bottom plate extends perpendicular to a rotation axis of a disk and a swing axis of a head. The rotation axis extends vertically. The swing axis is disposed in a different position from the rotation axis and extends vertically. The head reads or writes information from or to the disk. The pivot post protrudes upward from an upper surface of the bottom plate along the swing axis, and a portion of the die cast member is segregated.

### CROSS REFERENCE TO RELATED APPLICATIONS

The present invention claims priority under 35 U.S.C. § 119 to Japanese Application No. 2021-024677 filed on Feb. 18, 2021 the entire content of which is incorporated herein by reference.

### FIELD OF THE INVENTION

The present disclosure relates to a base plate, a spindle motor, a disk drive apparatus, and a manufacturing method of a base plate.

### BACKGROUND

A case body (base plate) being a portion of a housing of a conventional disk drive apparatus includes a bottom surface part having a rectangular shape and an actuator attachment part (pivot post). The actuator attachment part protrudes upward from an upper surface of the bottom surface part.

However, in the conventional case body, the fluidity of molten metal to the actuator attachment part is poor during casting and molding, and a shrinkage cavity may occur in the actuator attachment part. Hence, there is a possibility that helium gas filled inside the housing may leak to the outside via the actuator attachment part.

### SUMMARY

An exemplary base plate of the present disclosure is a base plate being a portion of a housing of a disk drive apparatus. The base plate includes a base body defined by a metal die cast member, and an electrodeposition coating film covering at least a portion of a surface of the base body. The base body includes a bottom plate having a rectangular shape as viewed from an axial direction, and a pivot post. The bottom plate extends perpendicular to a rotation axis of a disk and a swing axis of a head. The rotation axis extends vertically. The swing axis is disposed in a different position from the rotation axis and extends vertically. The head reads or writes information from or to the disk. The pivot post protrudes upward from an upper surface of the bottom plate along the swing axis, and a portion of the die cast member is segregated.

An exemplary manufacturing method of a base plate of the present disclosure is a manufacturing method of a base plate being a portion of a housing of a disk drive apparatus. The manufacturing method includes a casting process, a pressing process, an electrodeposition coating process, and a cutting process. In the casting process, a base body that includes a bottom plate having a rectangular shape as viewed from an axial direction and a pivot post is integrally cast by a mold. The bottom plate extends perpendicular to a rotation axis of a disk that extends vertically and a swing axis of a head. The swing axis is disposed in a different position from the rotation axis and extends vertically. The head reads or writes information from or to the disk. The pivot post protrudes upward from an upper surface of the bottom plate along the swing axis. In the pressing process, a tip of the pivot post or a lower surface of the bottom plate opposed to the pivot post in the axial direction is locally pressed in the axial direction in the mold. In the electrodeposition coating process, an electrodeposition coating film is provided on a surface of the base body. In the cutting process, the pivot post is cut and shaped.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a longitudinal sectional view of a disk drive apparatus according to an exemplary embodiment of the present disclosure.

FIG. 2 is a perspective view schematically illustrating a base plate according to an exemplary embodiment of the present disclosure.

FIG. 3 is a top view schematically illustrating a base plate according to an exemplary embodiment of the present disclosure.

FIG. 4 is a longitudinal sectional view schematically illustrating a base plate according to an exemplary embodiment of the present disclosure.

FIG. 5 is a flowchart illustrating a manufacturing process of a base plate according to an exemplary embodiment of the present disclosure.

FIG. 6 is an explanatory diagram describing a manufacturing process of a base plate according to an exemplary embodiment of the present disclosure.

FIG. 7 is an explanatory diagram describing a manufacturing process of a base plate according to an exemplary embodiment of the present disclosure.

FIG. 8 is an explanatory diagram describing a manufacturing process of a base plate according to an exemplary embodiment of the present disclosure.

FIG. 9 is an explanatory diagram describing a manufacturing process of a base plate according to an exemplary embodiment of the present disclosure.

FIG. 10 is an explanatory diagram describing a manufacturing process of a base plate according to an exemplary embodiment of the present disclosure.

FIG. 11 is an explanatory diagram describing a modification of a manufacturing process of a base plate according to an exemplary embodiment of the present disclosure.

### DETAILED DESCRIPTION

Exemplary embodiments of the present disclosure are described in detail with reference to the drawings. In the present specification, a rotation axis C of a disk 50 and a swing axis D of a head extend parallel to each other in different positions. In the present application, a direction parallel to the rotation axis C or the swing axis D, a direction orthogonal to the swing axis D, and a direction along an arc centered on the rotation axis C or the swing axis D are referred to as an “axial direction”, a “radial direction”, and a “circumferential direction”, respectively. In the present application, the shape and positional relationship of each part are described by taking the axial direction as an up-down direction and a cover 42 side as an upper side with respect to a base plate 41. However, this definition of the up-down direction does not intend to limit the orientation of the base plate 41 and a disk drive apparatus 1 according to the present disclosure during use.

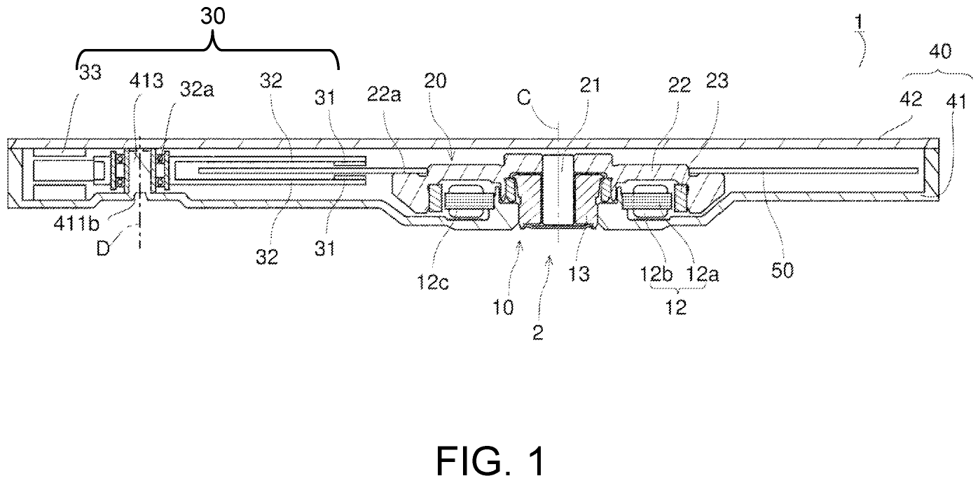

The disk drive apparatus 1 of an exemplary embodiment of the present disclosure is described. FIG. 1 is a longitudinal sectional view of the disk drive apparatus 1 according to an exemplary embodiment of the present disclosure.

The disk drive apparatus 1 is a hard disk drive. The disk drive apparatus 1 includes a spindle motor 2, the disk 50, a head 31, an arm 32, a swing mechanism 33, and a housing 40.

The housing 40 houses therein the spindle motor 2, the disk 50, the head 31, and the arm 32.

A gas having a density lower than that of air is filled inside the housing 40. Specifically, helium gas is filled. Hydrogen gas or the like may be filled instead of the helium gas.

The housing 40 is defined by a cast and molded metal die cast member including an aluminum alloy as a material. A metal other than aluminum alloy may be used for the die cast member.

The housing 40 includes the base plate 41 and the cover 42. Inside the housing 40, the disk 50, the spindle motor 2 and an access part 30 are disposed on the base plate 41. An upper opening of the base plate 41 is closed by the cover 42. The base plate 41 will be described in detail later.

The spindle motor 2 rotates the disk 50 about the rotation axis C while supporting the disk 50. That is, the disk 50 is rotated about the rotation axis C by the spindle motor 2. The spindle motor 2 includes a stationary part 10 and a rotary part 20. The stationary part 10 is stationary relative to the housing 40. The rotary part 20 is rotatably supported with respect to the stationary part 10.

The stationary part 10 includes a stator 12 and a bearing unit 13. A portion of the base plate 41 defines the stationary part 10. That is, the spindle motor 2 includes the base plate 41. The base plate 41 extends perpendicular to the rotation axis C on a lower side of the rotary part 20. The base plate 41 is a portion of the spindle motor 2 as well as a portion of the housing 40. The stator 12 and the bearing unit 13 are fixed to the base plate 41.

The stator 12 includes a stator core 12a being a magnetic body, and multiple coils 12b. The stator core 12a has multiple teeth 12c protruding radially outward. The multiple coils 12b are defined by lead wires wound around the teeth 12c.

The bearing unit 13 rotatably supports a shaft 21 on the rotary part 20 side. A fluid dynamic pressure bearing mechanism, for example, is used for the bearing unit 13.

The rotary part 20 includes the shaft 21, a hub 22, and a magnet 23. The shaft 21 is a member having a columnar or substantially columnar shape extending in the axial direction. A lower end of the shaft 21 is housed inside the bearing unit 13.

The hub 22 is fixed to an upper end of the shaft 21 and extends radially outward. An upper surface of an outer peripheral part 22a of the hub 22 supports the disk 50. The magnet 23 is fixed to an inner peripheral surface of the hub 22 and is disposed at a predetermined distance radially outside of the stator 12 and facing the stator 12. The magnet 23 has an annular or substantially annular shape, and the N pole and the S pole are alternately magnetized in the circumferential direction on an inner peripheral surface of the magnet 23.

When a drive current is supplied to the coils 12b, a magnetic flux is generated in the multiple teeth 12c. Torque in the circumferential direction is generated by interaction of the magnetic flux between the teeth 12c and the magnet 23. As a result, the rotary part 20 rotates about the rotation axis C with respect to the stationary part 10. The disk 50 supported by the hub 22 rotates about the rotation axis C together with the rotary part 20.

The disk 50 is an information recording medium having a discoid shape and having a hole in a central part. Each disk 50 is mounted on the spindle motor 2 and is disposed parallel to each other and at equal intervals in the axial direction via a spacer (not illustrated).

The head 31 magnetically reads or writes information from or to the disk 50. The arm 32 is attached to a tip of a later-described pivot post 413 of the base plate 41 via a bearing 32a. The head 31 is provided at a tip of the arm 32.

The swing mechanism 33 is a mechanism for swinging the arm 32 and the head 31. When the swing mechanism 33 is driven, the arm 32 swings about the swing axis D. That is, the head 31 swings about the swing axis D by the swing mechanism 33 via the arm 32. At this time, the head 31 moves relative to the disk 50, and approaches and accesses the disk 50 that rotates.

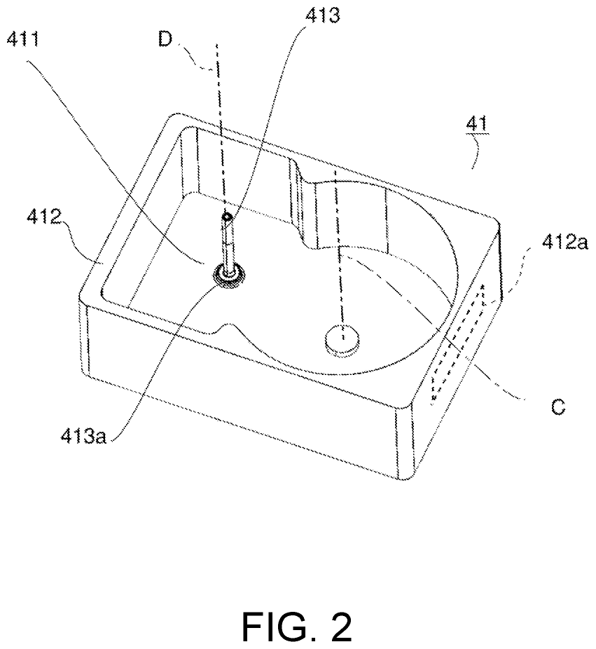

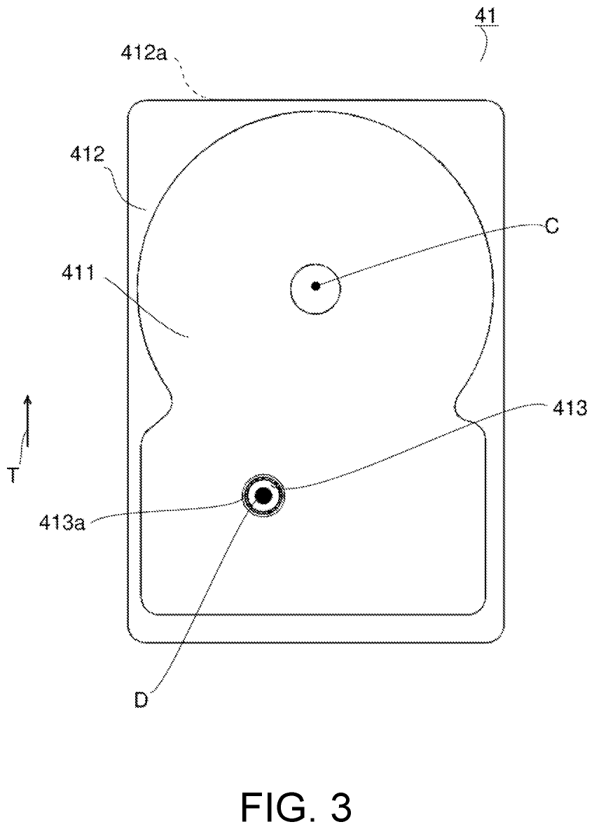

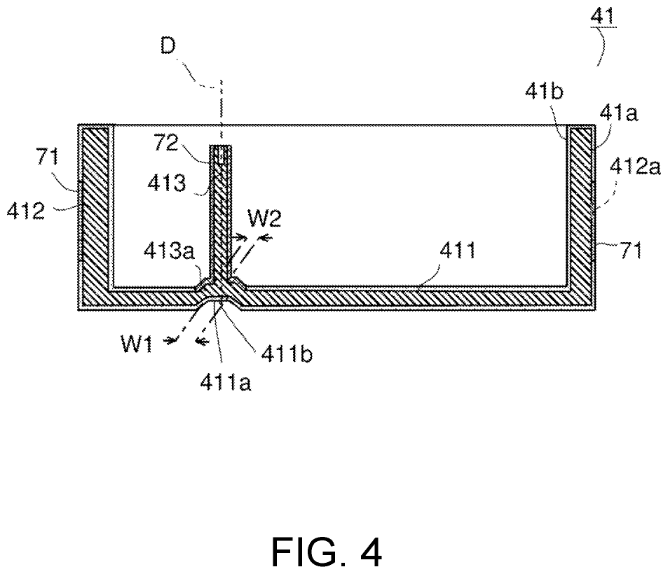

FIG. 2 is a perspective view schematically illustrating the base plate 41, and FIG. 3 is a top view schematically illustrating the base plate 41. FIG. 4 is a longitudinal sectional view schematically illustrating the base plate 41. A gate mark 412a illustrated in FIG. 4 is illustrated for description, while vestiges are removed in a later-described manufacturing process of the base plate 41.

The base plate 41 includes a base body 41a defined by a metal die cast member, and an electrodeposition coating film 41b covering a surface of the base body 41a.

The base body 41a is provided in a box shape with an open top, and includes a bottom plate 411 and a peripheral wall 412. The bottom plate 411 has a rectangular or substantially rectangular shape as viewed from the axial direction, and extends perpendicular to the rotation axis C and the swing axis D.

The peripheral wall 412 is defined by multiple walls extending upward from an outer peripheral edge of the bottom plate 411 and surrounding the bottom plate 411. The cover 42 is disposed on an upper end surface of the peripheral wall 412 and is, for example, screwed. The peripheral wall 412 includes the gate mark 412a where a gate 214 was connected during casting. The gate mark 412a is disposed on an outer surface of the peripheral wall 412 intersecting a parallel direction in which the rotation axis C and the swing axis D are lined up and facing the rotation axis C.

The pivot post 413 protrudes upward from an upper surface of the bottom plate 411 along the swing axis D and is provided in a columnar or substantially columnar shape. The pivot post 413 includes a pedestal 413a having an annular or substantially annular shape and protruding radially outward from a peripheral surface of a root portion. By providing the pedestal 413a, rigidity of the pivot post 413 at the root portion is able to be improved.

The bottom plate 411 includes a concave part 411a. The concave part 411a is defined by a lower surface of the bottom plate 411 opposed to the pivot post 413 in the axial direction being recessed upward in the axial direction. By providing the concave part 411a, the base plate 41 is able to be reduced in weight. As will be described later, by providing the concave part 411a, the flow of molten metal is turned upward during casting, and the fluidity of molten metal to the tip side of the pivot post 413 is able to be promoted.

The concave part 411a is a recess having a conical trapezoidal or substantially conical trapezoidal shape and is circular or substantially circular in bottom view. That is, an inner diameter of the concave part 411a is defined to gradually decrease upward in the axial direction. A top surface 411b disposed at a tip on an axially upper side of the concave part 411a is defined substantially parallel to the lower surface of the bottom plate 411. In the base plate 41 of a finished product, a diameter W1 of the top surface 411b is larger than an outer diameter W2 of the root portion of the pivot post 413 at an upper end of the pedestal 413a. The diameter W1 of the top surface 411b may be substantially the same as the outer diameter W2 of the root portion of the pivot post 413 at the upper end of the pedestal 413a.

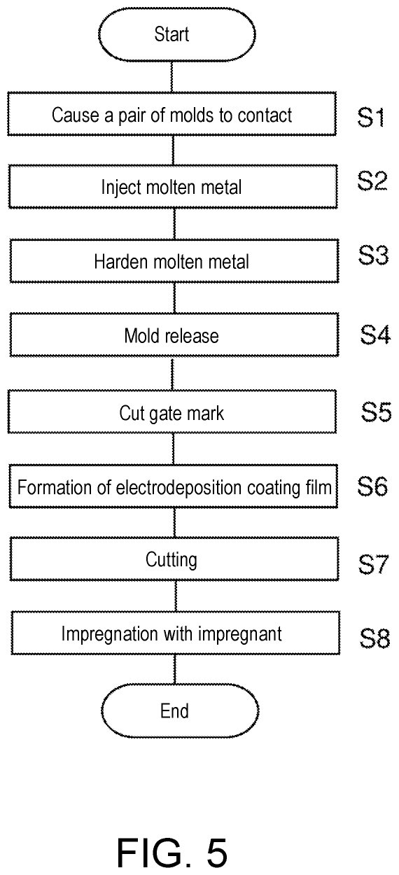

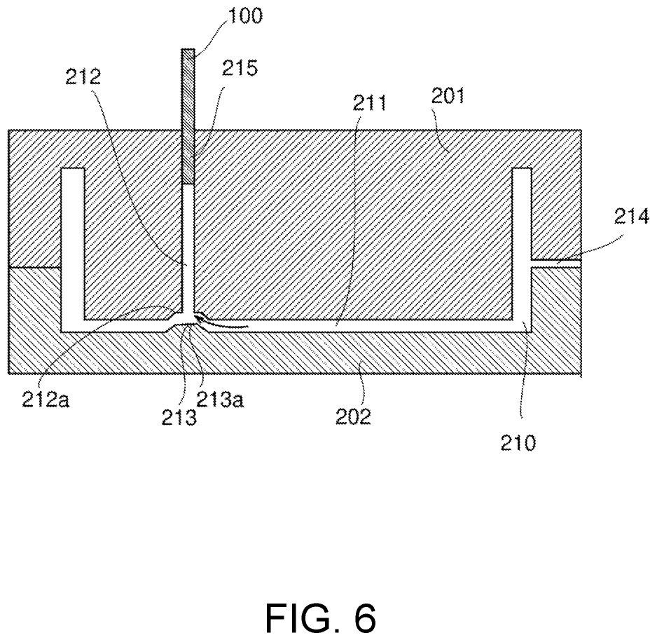

FIG. 5 is a flowchart illustrating a manufacturing process of the base plate 41. FIG. 6 to FIG. 10 are explanatory diagrams describing a manufacturing process of the base plate 41.

In step S1, as illustrated in FIG. 6, a peripheral edge of a mold 201 and a peripheral edge of a mold 202 are brought into contact with each other in the up-down direction, and a cavity 210 is defined between the mold 201 and the mold 202. The cavity 210 has a shape corresponding to the shape of the base body 41a. The cavity 210 communicates with the gate 214 extending along facing surfaces of the mold 201 and the mold 202. An outer end of the gate 214 opens to the outside of the mold 201 and the mold 202.

On the facing surfaces of the mold 201 and the mold 202, an air bleeding flow path (not illustrated) for bleeding air in the cavity 210 is provided separately from the gate 214. An outer end of the air bleeding flow path opens to the outside of the mold 201 and the mold 202.

The cavity 210 includes a plate-shaped part 211, a convex part 212, a recess 213, and a through hole 215. The molten metal flows into the plate-shaped part 211 and the bottom plate 411 is defined.

The convex part 212 extends upward in the axial direction from the plate-shaped part 211 and is provided in a columnar or substantially columnar shape. The molten metal flows into the convex part 212 and the pivot post 413 is defined. The convex part 212 includes a pedestal convex part 212a having an annular or substantially annular shape and protruding radially outward from a peripheral surface of a root portion. The molten metal flows into the pedestal convex part 212a and the pedestal 413a is defined.

The recess 213 faces the convex part 212 in the up-down direction, and is defined by a lower surface of the plate-shaped part 211 protruding upward in the axial direction. By the recess 213, the concave part 411a is defined when the molten metal flows into the plate-shaped part 211. A diameter of the recess 213 is defined to gradually decrease upward in the axial direction. A recess top surface 213a disposed at a tip on an axially upper side of the recess 213 is defined substantially parallel to the lower surface of the plate-shaped part 211.

The through hole 215 extends upward in the axial direction from an upper end of the convex part 212 and opens to the outside of the mold 201. An inner diameter of the through hole 215 and an inner diameter of the convex part 212 are substantially the same. A squeeze pin 100 is inserted inside the through hole 215. The squeeze pin 100 is slidable in the axial direction inside the through hole 215. At this time, a lower end of the squeeze pin 100 is able to be inserted into the convex part 212.

In step S2, the molten metal is injected into the cavity 210 via the gate 214. The molten metal is, for example, a molten aluminum alloy. When the molten metal is injected into the cavity 210, the air in the cavity 210 or a gas generated from the molten metal is pushed out of the mold 201 and the mold 202 from the air bleeding flow path. Accordingly, the molten metal spreads throughout the cavity 210.

At this time, by the recess 213, the flow of molten metal is turned upward, and the flow into the convex part 212 is facilitated. Accordingly, the occurrence of shrinkage cavities in the pivot post 413 is able to be reduced. The diameter of the recess 213 is defined to gradually decrease upward in the axial direction, and the flow of molten metal is able to be smoothly turned upward.

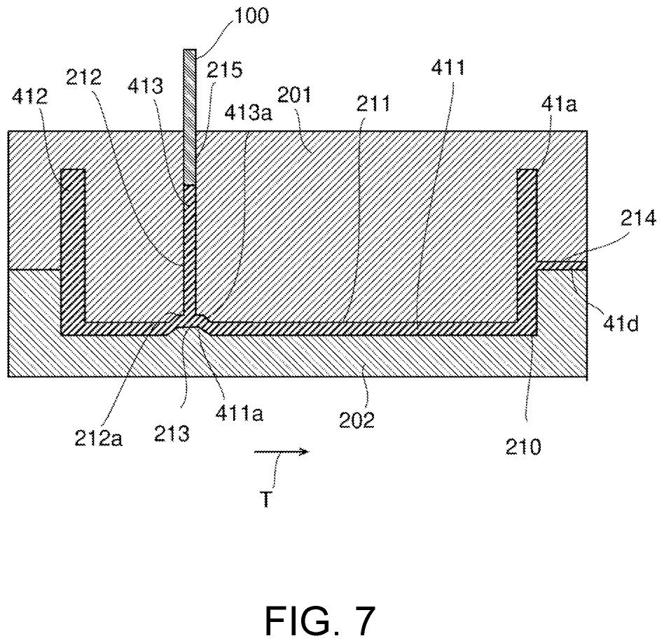

In step S3, after the molten metal has spread throughout the cavity 210, the molten metal is cooled and hardened. Accordingly, the base body 41a (see FIG. 7) is defined in the cavity 210. A chill layer (not illustrated) is defined on the surface of the base body 41a. When the molten metal is hardened, the chill layer is defined where the mold 201 and the mold 202 are in contact and the hardening is fast. The chill layer in which hardening of the molten metal is faster than other portions has few impurities and a high metal density.

As illustrated in FIG. 7, the squeeze pin 100 is pushed into the convex part 212, and the pivot post 413 is cooled and hardened while the tip of the pivot post 413 is locally pressed in the axial direction in the mold 201. Accordingly, in the pivot post 413, a portion of the die cast member is segregated, and the occurrence of shrinkage cavities is able to be further reduced.

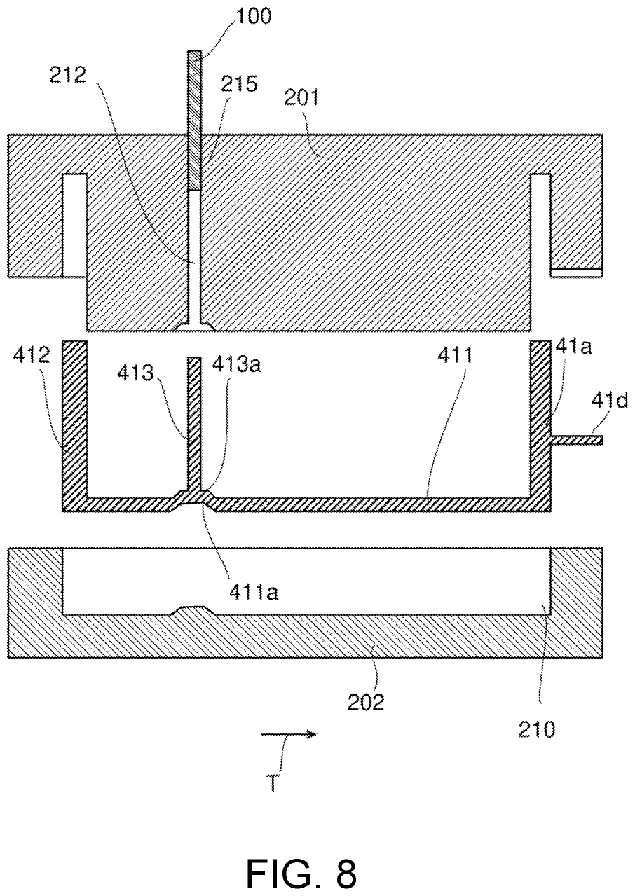

In step S4, the base body 41a is released from the pair of molds 201 and 202, as illustrated in FIG. 8. At this time, the peripheral wall 412 includes a gate mark 41d protruding from the outer surface. The gate mark 41d is defined by hardening the molten metal accumulated at the gate 214 and the air bleeding flow path (not illustrated).

In step S5, the gate mark 41d is cut. The gate mark 412a defined by cutting the gate mark 41d slightly protrudes from the outer surface of the peripheral wall 412 and a vestige is left.

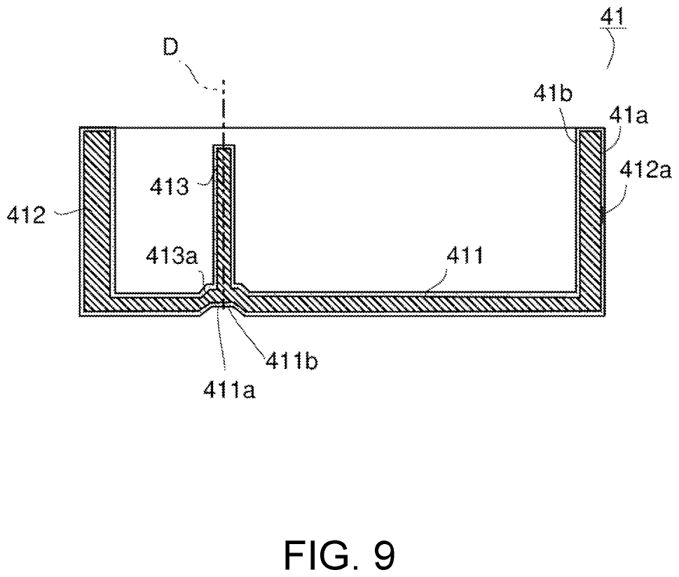

In step S6, as illustrated in FIG. 9, the electrodeposition coating film 41b is provided on the surface of the base body 41a. In the electrodeposition coating film 41b, the base body 41a is immersed in, for example, a coating material of an epoxy resin, and an electric current flows between the coating material and the base body 41a. Accordingly, the coating material adheres to the surface of the base body 41a, and the electrodeposition coating film 41b is provided on the surface of the base body 41a. At this time, an outer surface of the gate mark 412a is also covered with the electrodeposition coating film 41b.

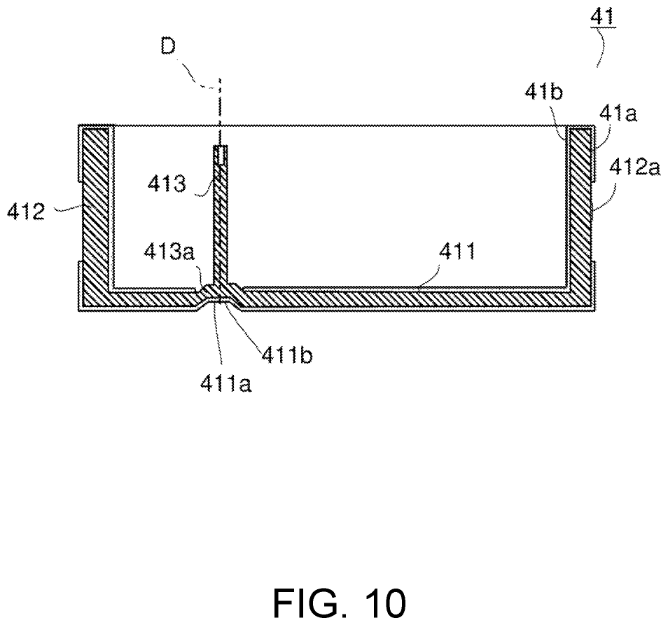

In step S7, as illustrated in FIG. 10, in the surface of the base body 41a, the pivot post 413 for which accuracy is required undergoes precision machining and shaping by cutting.

By cutting of the surface of the base body 41a, the electrodeposition coating film 41b is also cut, and a second machined surface 72 is defined on the surface of the base body 41a. That is, the second machined surface 72 defined by cutting and machining the surface of the base body 41a is defined in at least a portion of the peripheral surface of the pivot post 413. In the present embodiment, the second machined surface 72 is defined on the entire peripheral surface of the pivot post 413. In the second machined surface 72, the surface of the base body 41a is exposed from the electrodeposition coating film 41b.

In step S7, the entire outer surface of the peripheral wall 412 including the gate mark 412a defined when the gate mark 41d is cut in step S5 is cut and shaped. At this time, the electrodeposition coating film 41b on the outer peripheral surface of the peripheral wall 412 is cut, and a first machined surface 71 is defined. That is, in at least a portion of the peripheral wall 412, the first machined surface 71 defined by cutting and machining the surface of the base body 41a is defined so as to include at least a portion of the gate mark 412a. In the present embodiment, in the first machined surface 71, the surface of the base body 41a is exposed from the electrodeposition coating film 41b. The first machined surface 71 includes at least a portion of the gate mark 412a and is defined on the entire outer surface of the peripheral wall 412. Accordingly, the gate mark 412a defined by the molten metal accumulated at the gate 214 and the air bleeding flow path (not illustrated) is able to be shaped by a series of operations. Therefore, workability in the cutting process is improved.

In the present embodiment, the first machined surface 71 is defined on the entire outer surface of the peripheral wall 412. However, the first machined surface 71 may be defined on only one surface of the peripheral wall 412 that includes the gate mark 412a. The first machined surface 71 may also be defined across one surface of the peripheral wall 412 that includes the gate mark 412a and at least one surface adjacent to the one surface.

In step S7, the gate mark 412a is removed by cutting and there is no vestige. However, in order to describe the vestige where a gate was connected during casting, the gate mark 412a is illustrated in broken lines in the drawings.

In step S8, the base body 41a is immersed in an impregnant. At this time, the impregnant infiltrates into at least a portion of the second machined surface 72 from which the electrodeposition coating film 41b has been cut and into at least a portion of the first machined surface 71. As the impregnant, for example, an epoxy resin or an acrylic resin is used. Accordingly, in at least a portion of the second machined surface 72 and at least a portion of the first machined surface 71, a small cavity defined on the surface of the base body 41a is sealed with the impregnant. Accordingly, the helium gas filled inside the housing 40 is able to be prevented from leaking to the outside via the second machined surface 72 and the first machined surface 71.

The impregnant has less viscosity than the coating material defining the electrodeposition coating film 41. Hence, compared with the coating material defining the electrodeposition coating film 41, the impregnant is more likely to impregnate the small cavity defined on the surface of the base body 41a.

A manufacturing method of the base plate 41 being a portion of the housing 40 of the disk drive apparatus 1 includes a casting process, an electrodeposition coating process, a cutting process, and an impregnation process in order. In the casting process, the base body 41a that includes the bottom plate 411 and the pivot post 413 is integrally cast by the molds 201 and 202 (steps S1 to S4). In the electrodeposition coating process, the electrodeposition coating film 41b is provided on the surface of the base body 41a (step S6). In the cutting process, the pivot post 413 is cut and shaped (step S7). The impregnation process is after the cutting process, in which a machined surface where the surface of the base body 41a is exposed from the electrodeposition coating film 41b is impregnated with the impregnant (step S8).

In the casting process, by cooling and hardening the pivot post 413 while locally pressing the tip of the pivot post 413 in the axial direction, in the pivot post 413, a portion of the die cast member is segregated, and the occurrence of shrinkage cavities is able to be further reduced.

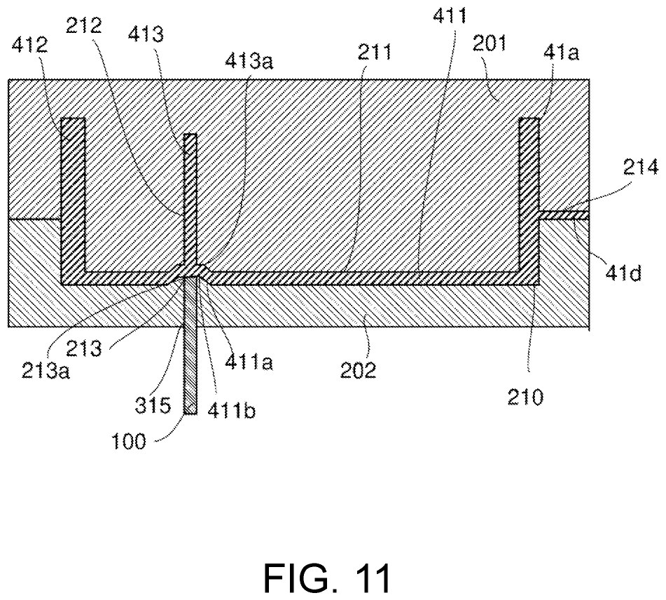

FIG. 11 is an explanatory diagram describing a modification of a manufacturing process of the base plate 41. A through hole 315 is provided in the mold 202, communicates with the plate-shaped part 211 and extends downward in the axial direction from an upper end of the recess 213. A lower end of the through hole 315 opens to the outside of the mold 202. The squeeze pin 100 is inserted inside the through hole 315. The squeeze pin 100 is slidable in the axial direction inside the through hole 315. At this time, an upper end of the squeeze pin 100 is able to be inserted into the plate-shaped part 211.

In step S4, the squeeze pin 100 is pushed into the plate-shaped part 211, and the pivot post 413 is cooled and hardened while the lower surface of the bottom plate 411 opposed to the pivot post 413 in the axial direction is locally pressed in the axial direction in the mold 201. Accordingly, in the pivot post 413, a portion of the die cast member is segregated, and the occurrence of shrinkage cavities is able to be further reduced.

At this time, the recess top surface 213a is defined substantially parallel to the lower surface of the plate-shaped part 211. Accordingly, the squeeze pin 100 is brought into contact with the recess top surface 213a and uniform pressing upward in the axial direction is possible. Accordingly, the occurrence of shrinkage cavities in the pivot post 413 is able to be further reduced.

For example, in the present embodiment, the concave part 411a is defined on the lower surface of the bottom plate 411. However, the lower surface of the bottom plate 411 opposed to the pivot post 413 in the axial direction may be defined flat. Accordingly, the lower surface of the bottom plate 411 is likely to be pressed with the squeeze pin 100 in the axial direction. Therefore, workability in the pressing process is improved.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

According to the present disclosure, the present disclosure is able to be used in, for example, a housing used in a disk drive apparatus such as a hard disk drive.

What is claimed is:

1. A base plate being a portion of a housing of a disk drive apparatus, comprising:
a base body defined by a metal die cast member; and
an electrodeposition coating film covering at least a portion of a surface of the base body, wherein
the base body comprises:
a bottom plate having a rectangular shape as viewed from an axial direction; and
a pivot post, wherein
the bottom plate extends perpendicular to a rotation axis of a disk and a swing axis of a head, the rotation axis extending vertically, the swing axis being disposed in a different position from the rotation axis and extending vertically, the head reading or writing information from or to the disk;
the pivot post protrudes upward from an upper surface of the bottom plate along the swing axis, and a portion thereof is segregated.

2. The base plate according to claim 1, wherein
the bottom plate comprises a concave part defined by a lower surface of the bottom plate opposed to the pivot post in the axial direction being recessed upward in the axial direction.

3. The base plate according to claim 2, wherein
an inner diameter of the concave part decreases upward in the axial direction.

4. The base plate according to claim 2, wherein
the concave part has a top surface disposed at a tip on an axially upper side and substantially parallel to the lower surface of the bottom plate.

5. The base plate according to claim 4, wherein
the pivot post comprises a pedestal having an annular shape and protruding radially outward from a peripheral surface of a root portion;
a diameter of the top surface is substantially the same as or larger than an outer diameter of the root portion of the pedestal at an upper end of the pivot post.

6. The base plate according to claim 1, wherein
a lower surface of the bottom plate opposed to the pivot post in the axial direction is defined flat.

7. The base plate according to claim 1, wherein
the base body comprises a peripheral wall extending upward from an outer peripheral edge of the bottom plate and surrounding the bottom plate;
the peripheral wall comprises a gate mark where a gate was connected during casting;
the gate mark is disposed on an outer surface of the peripheral wall intersecting a parallel direction in which the rotation axis and the swing axis are lined up and facing the rotation axis;
in at least a portion of the peripheral wall, a first machined surface defined by cutting and machining the surface of the base body is defined so as to comprise at least a portion of the gate mark.

8. The base plate according to claim 7, wherein
in the peripheral wall, the first machined surface is defined across one surface of the peripheral wall that comprises the gate mark and at least one surface adjacent to the one surface.

9. The base plate according to claim 7, wherein
the first machined surface is defined on the entire outer surface of the peripheral wall.

10. The base plate according to claim 7, wherein
at least a portion of the first machined surface is infiltrated with an impregnant.

11. The base plate according to claim 1, wherein
a second machined surface defined by cutting and machining the surface of the base body is defined in at least a portion of a peripheral surface of the pivot post.

12. The base plate according to claim 11, wherein
at least a portion of the second machined surface is infiltrated with an impregnant.

13. The base plate according to claim 10, wherein
the impregnant is either an epoxy resin or an acrylic resin.

14. The base plate according to claim 12, wherein
the impregnant is either an epoxy resin or an acrylic resin.

15. A spindle motor, comprising the base plate according to claim 1.

16. A disk drive apparatus, comprising:
the spindle motor according to claim 15;
a disk rotated about the rotation axis by the spindle motor; and
a head swinging about the swing axis and reading or writing information from or to the disk.

17. The disk drive apparatus according to claim 16, wherein
a gas having a density lower than that of air is filled inside the housing.

18. A manufacturing method of a base plate, the base plate being a portion of a housing of a disk drive apparatus, wherein the manufacturing method comprises, in order:
a casting process in which a base body is integrally cast by a mold, the base body comprising:
a bottom plate having a rectangular shape as viewed from an axial direction, extending perpendicular to a rotation axis of a disk and a swing axis of a head, the rotation axis extending vertically, the swing axis being disposed in a different position from the rotation axis and extending vertically, the head reading or writing information from or to the disk; and
a pivot post, protruding upward from an upper surface of the bottom plate along the swing axis;
an electrodeposition coating process in which an electrodeposition coating film is provided on a surface of the base body; and
a cutting process in which the pivot post is cut and shaped, wherein
in the casting process, the pivot post is cooled and hardened while a tip of the pivot post or a lower surface of the bottom plate opposed to the pivot post in the axial direction is locally pressed in the axial direction in the mold.

19. The manufacturing method of a base plate according to claim 18, comprising, after the cutting process:
an impregnation process in which a machined surface where the surface of the base body is exposed from the electrodeposition coating film is impregnated with an impregnant.
